(19) United States
(12) Patent Application Publication
(10) Pub. No.: US 2024/0250936 A1
(43) Pub. Date: Jul. 25, 2024

(54) METHODS AND SYSTEMS FOR GENERATING A SECURE COMMUNICATION CHANNEL INTERFACE FOR VIDEO STREAMING OF SENSITIVE CONTENT

(71) Applicant: KPN INNOVATIONS LLC, Lakewood, CO (US)

(72) Inventor: Kenneth Neumann, LAKEWOOD, CO (US)

(73) Assignee: KPN INNOVATIONS LLC, Lakewood, CO (US)

(21) Appl. No.: 18/625,477

(22) Filed: Apr. 3, 2024

Related U.S. Application Data
(63) Continuation-in-part of application No. 17/833,634, filed on Jun. 6, 2022, now Pat. No. 11,968,189.
Application No. 17/833,634 is a continuation of application No. 16/919,674, filed on Jul. 2, 2020, now Pat. No. 11,394,695.

(51) Int. Cl. H04L 9/40; G06F 21/62; H04L 65/1069; H04L 65/60; H04L 67/52

(52) U.S. Cl. CPC H04L 63/0428; G06F 21/6245; H04L 63/08; H04L 65/1069; H04L 65/60; H04L 67/52

(57) ABSTRACT

Described herein are systems and methods for generating a secure communication channel interface. Such a system may include a computing device configured to transmit, to a user client device, a configuration packet uniquely identifying the computing device; receive, from the user client device, an authentication datum; initiate a secure communication channel interface with the user client device as a function of the authentication datum; establish a security baseline parameter, wherein establishing the security baseline parameter includes identifying a network parameter; identifying a baseline audiovisual measurement; identifying a biometric identifier of a user; and identifying a user environment landmark comprising a physical object; identify a user health datum as a function of the security baseline parameter; share a health record of the user health datum using the secure communication channel interface; and transcribe audio information of the user health datum transmitted over the secure communication channel interface.

### CROSS-REFERENCE TO RELATED APPLICATIONS

This application is a continuation-in-part of Non-provisional application Ser. No. 17/833,634 filed on Jun. 6, 2022, and entitled “METHODS AND SYSTEMS FOR GENERATING A SECURE COMMUNICATION CHANNEL INTERFACE FOR VIDEO STREAMING OF SENSITIVE CONTENT,” which is a continuation of Non-provisional application Ser. No. 16/919,674 filed on Jul. 2, 2020, now U.S. Pat. No. 11,394,695 issued on Jul. 19, 2022 and entitled “METHODS AND SYSTEMS FOR GENERATING A SECURE COMMUNICATION CHANNEL INTERFACE FOR VIDEO STREAMING OF SENSITIVE CONTENT,” the entirety of each of which is incorporated herein by reference.

### FIELD OF THE INVENTION

The present invention generally relates to the field of security. In particular, the present invention is directed to methods and systems for generating a secure communication channel interface for video streaming of sensitive content.

### BACKGROUND

Network connections can be susceptible to attack, leading to publication of private and sensitive information. Frequently, this can leave users unable to securely communicate, particularly in situations in need of immediate attention.

### SUMMARY OF THE DISCLOSURE

In an aspect, a system for generating a secure communication channel interface may include a computing device configured to transmit, to a user client device, a configuration packet uniquely identifying the computing device; receive, from the user client device, an authentication datum; initiate a secure communication channel interface with the user client device as a function of the authentication datum; establish a security baseline parameter, wherein establishing the security baseline parameter includes identifying a network parameter; identifying a baseline audiovisual measurement; identifying a biometric identifier of a user; and identifying a user environment landmark comprising a physical object; identify a user health datum as a function of the security baseline parameter; share a health record of the user health datum using the secure communication channel interface; and transcribe audio information of the user health datum transmitted over the secure communication channel interface.

In another aspect, a method of generating a secure communication channel interface includes, using at least a processor of a computing device, transmitting, to a user client device, a configuration packet uniquely identifying the computing device; using the at least a processor, receiving, from the user client device, an authentication datum; using the at least a processor, initiating a secure communication channel interface with the user client device as a function of the authentication datum; using the at least a processor, establishing a security baseline parameter, wherein establishing the security baseline parameter includes identifying a network parameter; identifying a baseline audiovisual measurement; identifying a biometric identifier of a user; and identifying a user environment landmark comprising a physical object; using the at least a processor, identifying a user health datum as a function of the security baseline parameter; using the at least a processor, sharing a health record of the user health datum using the secure communication channel interface; and using the at least a processor, transcribing audio information of the user health datum transmitted over the secure communication channel interface.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of a system for generating a secure communication channel interface;

FIG. 2 is a block diagram illustrating an exemplary embodiment of a security database;

FIG. 3 is a diagrammatic representation of an exemplary secure communication channel interface;

FIGS. 4A and 4B are diagrammatic representations of an exemplary system for detecting a change in security;

FIG. 5 is a diagrammatic representation of an exemplary system for detecting a change in local network;

FIG. 6 is a box diagram of an exemplary machine learning model;

FIG. 7 is a diagram of an exemplary neural network;

FIG. 8 is a diagram of an exemplary neural network node;

FIG. 9 is a flow diagram depicting an exemplary embodiment of a method of generating a secure communication channel interface;

FIG. 10 is a flow diagram depicting an exemplary embodiment of a method of establishing a security baseline parameter;

FIG. 11 is a flow diagram depicting an exemplary embodiment of a method of generating a secure communication channel interface for video streaming of sensitive content;

FIG. 12 is a flow diagram depicting an exemplary embodiment of a method of generating a secure communication channel interface; and

FIG. 13 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for generating a secure communication channel interface for video streaming of sensitive content. In an embodiment, a secure communication channel interface is initiated between a user client device and a computing device. A security baseline parameter is established and utilized to detect a change in security. Computing device is configured to execute a mitigation action to prevent a security breach.

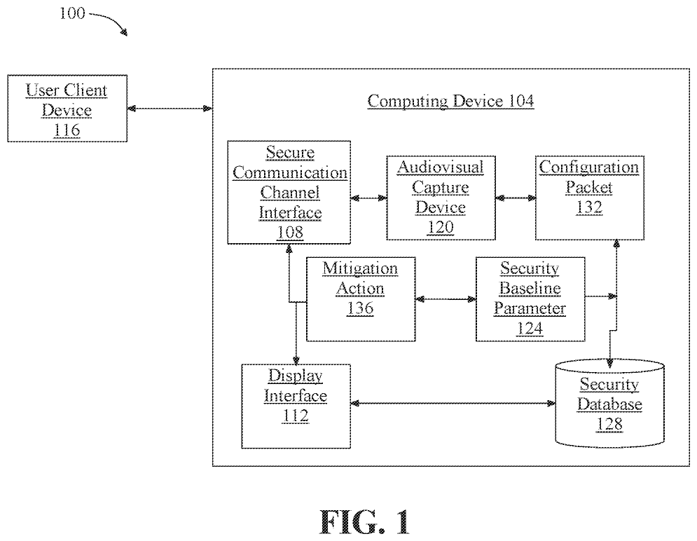

Referring now to FIG. 1, an exemplary embodiment of a system 100 for generating a secure communication channel interface for video streaming of sensitive content is illustrated. System 100 includes a computing device 104. Computing device 104 may include any computing device 104 as described in this disclosure, including without limitation a microcontroller, microprocessor, digital signal processor (DSP) and/or system on a chip (SoC) as described in this disclosure. Computing device 104 may include, be included in, and/or connect with a mobile device such as a mobile telephone or smartphone. Computing device 104 may include a single computing device 104 operating independently or may include two or more computing device 104 operating in concert, in parallel, sequentially or the like; two or more computing devices 104 may be included together in a single computing device 104 or in two or more computing devices 104. Computing device 104 may interface or connect with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an association, a building, a campus or other relatively small geographic space), a telephone network, a data network associated with a telephone/voice provider (e.g., a mobile communications provider data and/or voice network), a direct connection between two computing devices 104, and any combinations thereof. A network may employ a wired and/or a wireless mode of communication. In general, any network topology may be used. Information (e.g., data, software etc.) may be transmitted to and/or from a computer and/or a computing device 104. Computing device 104 may include but is not limited to, for example, a computing device 104 or cluster of computing devices 104 in a first position and a second computing device 104 or cluster of computing devices 104 in a second position. Computing device 104 may include one or more computing devices 104 dedicated to data storage, security, dispersal of traffic for load balancing, and the like. Computing device 104 may distribute one or more computing tasks as described below across a plurality of computing devices 104 of computing device 104, which may operate in parallel, in series, redundantly, or in any other manner used for dispersal of tasks or memory between computing devices 104. Computing device 104 may be implemented using a “shared nothing” architecture in which data is cached at the operative, in an embodiment, this may enable scalability of system 100 and/or computing device 104.

Continuing to refer to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence recurrently until a desired or commanded outcome is achieved; repetition of a step or a sequence of steps may be performed iteratively and/or recursively using outputs of previous repetitions as inputs to subsequent repetitions, assembling inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 is configured to initiate a secure communication channel interface 108 between a user client device and computing device 104. A “secure communication channel interface,” as used in this disclosure, is a communication medium within an interface. A secure communication channel interface 108 may include an application, script, and/or program capable of providing a means of communication between at least two parties, including any oral and/or written forms of communication. A secure communication channel interface 108 may allow computing device 104 to interface with electronic devices through graphical icons, audio indicators including primary notation, text based user interfaces, typed command labels, text navigation, and the like. A secure communication channel interface 108 may include slides or other commands that may allow a user to select one or more options. A secure communication channel interface 108 may include free form textual entries, where a user may type in a response and/or message. A secure communication channel interface 108 includes a display interface 112. Display interface 112 includes a form or other graphical element having display fields, where one or more elements of information may be displayed. Display interface 112 may display data output fields including text, images, or the like containing one or more messages. A secure communication channel interface 108 may include data input fields such as text entry windows, drop-down lists, buttons, checkboxes, radio buttons, sliders, links, or any other data input interface that may capture user interaction as may occur to persons skilled in the art upon reviewing the entirety of this disclosure. A secure communication channel interface 108 may be provided, without limitation, using a web browser, a native application, a mobile application, and the like.

Still referring to FIG. 1, in some embodiments, computing device 104 may initiate secure communication channel interface 108 a user client device as a function of an authentication datum and/or a configuration packet. For example, computing device 104 may transmit a configuration packet to a user client device and may determine whether to initiate secure communication channel interface 108 as a function of receipt of an authentication datum from the user client device. For example, an authentication datum may confirm receipt of the configuration packet and/or may identify and/or verify identity of user client device.

With continued reference to FIG. 1, computing device 104 initiates a secure communication channel interface 108 with a user client device 116. A “user client device,” as used in this disclosure, is a second computing device, including for example a mobile device such as a smartphone, tablet, laptop, desktop, and/or any other type of device suitable for use as computing device 104. User client device 116 is operated by a user, including any human being. Computing device 104 initiates secure communication channel interface 108 using any network methodology as described herein. In an embodiment, a secure communication channel interface 108 may be utilized to facilitate communications between a user client device 116 operated by a first human being, and computing device 104 which may be operated by a second human being. For example, user client device 116 may be operated by a patient who is in communication with a medical professional operating computing device 104, and secure communication channel interface 108 may be utilized to have a telemedicine appointment. In yet another non-limiting example, user client device 116 may be operated by a first member of a support group, and computing device 104 may be operated by a second member of the support group, whereby secure communication channel interface 108 may be utilized to facilitate support group meetings and secure communications between members of the support group.

With continued reference to FIG. 1, a secure communication channel interface 108 includes an audiovisual capture device 120. An “audiovisual capture device,” as used in this disclosure, is a device used to record sound and/or images. An audiovisual capture device may include but is not limited to, a camera, a video camera, a mobile device, a recording device, a DVD player, a sensor, a television tuner, a video capture card, a universal serial bus (USB) audio and/or visual capture device, and the like. In an embodiment, an audiovisual capture device 120 may be located within user client device 116.

With continued reference to FIG. 1, computing device 104 is configured to establish a security baseline parameter 124 within secure communication channel interface 108. As used herein, a “security baseline parameter” is a data structure which describes a security state of a computing device. For example, a security baseline parameter may describe a security state of user client device 116 and/or computing device 104. A security baseline parameter 124 may be measured by computing device 104 and may capture one or more measurements using secure communication channel interface 108, display interface 112, and/or audiovisual capture device 120. Information relating to one or more security baseline parameters 124 may be stored within security database 128. Security database 128 may be implemented without limitation, as a relational database, a key-value retrieval datastore such as a NOSQL database, or any other format or structure for use as a datastore that a person skilled in the art would recognize as suitable upon review of the entirety of this disclosure. Establishing a security baseline parameter includes using audiovisual capture device 120 to establish a baseline user environment landmark. As used herein, a “user environment landmark” is a data structure describing a feature of an environment of a user, a computing device, or both. In some embodiments, a user environment landmark may be determined as a function of data capture by audiovisual capture device 120, such as a feature of an environment of a user captured by a camera associated with a computing device of the user. A user environment landmark may include but is not limited to any physical object located in a room and/or environment where a user is location, such as a couch that a user is sitting on, or a backdrop looking out onto a busy street when a user is sitting in the user's office at work. A user environment landmark may be established and/or captured using audiovisual capture device 120. For instance and without limitation, audiovisual capture device 120 may scan a room where a user is located, prior to initiating a meeting between the user and the user's functional medicine physician. In yet another non-limiting example, audiovisual capture device 120 may record baseline noise levels in a user's office, where a user is located and intendeds to have a video conference with the user's psychiatrist. A user environment landmark may include the user, including any distinguishing features and/or representations of the user, such as for example, any unique biometric identifiers such as a user's fingerprints, facial recognition, a user's voice, a user's signature, a DNA sequence, a measurement of a user's gait, and the like. A user environment landmark may include any geolocation data pertaining to a user, including any of the geolocation data as described herein. For example, a user's environment landmark may include the user's home address, where the user is located when the user engages in a telemedicine conference with the user's functional medicine doctor.

With continued reference to FIG. 1, initiating a secure communication channel interface 108 may include transmitting to user client device 116 a configuration packet 132 uniquely identifying computing device 104. A “configuration packet,” as used in this disclosure, is an encrypted message including a non-public device identifier. An encrypted message includes any language that contains text, characters, and/or symbols that have been converted into an alternative form, such as but not limited to ciphertext. An encrypted message may include using an algorithm and/or a series of algorithms to transform plaintext messages into ciphertext. Encrypted messages may only be viewed in a non-encrypted from by decrypting it using a correct decryption key. Encrypted messages may be decrypted using both symmetric and asymmetric cryptographic key pairs, such as for example a public and private key pair. An encrypted message may be generated in a manner that complies with the Health Insurance Portability and Accountability Act (HIPAA) of 1996. A message may be encrypted using a pseudo-random encryption key generated by an algorithm. In one embodiment, a process of converting plaintext into ciphertext is known as “encryption.” Encryption process may involve the use of a datum, known as an “encryption key,” to alter plaintext. Cryptographic system may also convert ciphertext back into plaintext, which is a process known as “decryption.” Decryption process may involve the use of a datum, known as a “decryption key,” to return the ciphertext to its original plaintext form. In embodiments of cryptographic systems that are “symmetric,” decryption key is essentially the same as encryption key: possession of either key makes it possible to deduce the other key quickly without further secret knowledge. Encryption and decryption keys in symmetric cryptographic systems may be kept secret and shared only with persons or entities that the user of the cryptographic system wishes to be able to decrypt the ciphertext. One example of a symmetric cryptographic system is the Advanced Encryption Standard (“AES”), which arranges plaintext into matrices and then modifies the matrices through repeated permutations and arithmetic operations with an encryption key. In some embodiments, a configuration packet may include a data structure which is communicated from computing device 104 to user client device 116. In some embodiments, a configuration packet may allow user client device 116 to confirm the identify and/or authenticity of computing device 104.

With continued reference to FIG. 1, a “non-public device identifier,” as used in this disclosure, is a decryption key that cannot be readily deduced without additional secret knowledge, such as for example, a private key. A non-public device identifier may include a randomly generated number that cannot be easily guessed. A non-public device identifier may be generated using a stream cipher and/or a block cipher. An encrypted message may be transmitted with a non-public device identifier, to initiate secure communication between computing device 104 and user client device 116.

With continued reference to FIG. 1, computing device 104 may receive from user device 104 an authentication datum. Computing device 104 may receive an authentication datum from user client device 116. User client device 116 may transmit to computing device 104 an authentication datum as a function of configuration packet 132. As used herein, an “authentication datum” is a data structure which indicates that a configuration packet has been received, authenticated, or both. In some embodiments, an authentication datum may allow computing device 104 to confirm the identify and/or authenticity of user client device 116. An authentication datum may be transmitted from user client device 116 to computing device 104 using any network methodology as described herein. In an embodiment, user client device 116 may receive from computing device 104 a configuration packet 132 uniquely identifying computing device 104. In an embodiment, computing device 104 may receive from user client device 116 a configuration packet 132 uniquely identifying user client device 116. In some embodiments, configuration packet 132 may uniquely identify user client device 116. In some embodiments, configuration packet 132 may authenticate configuration packet 132 and/or the identify of user client device 116. Computing device 104 may establish a communication exchange as a function of receiving from user client device 116 an authentication datum authenticating configuration packet 132 and/or acknowledging receipt of configuration packet 132. A communication exchange may include a telecommunication handshake that includes an automated process of communications between two or more participants, such as computing device 104 and user client device 116. A telecommunication handshake includes the exchange of information establishing protocols of communication at the start of communication, before full communication commences. A telecommunication handshake may include exchanging signals to establish a communication link as well as to agree as to which protocols to implement. A telecommunication handshake may include negotiating parameters to be utilized between user client device 116 and computing device 104, including information transfer rate, coding alphabet, parity, interrupt procedure, and/or any other protocol or hardware features. A telecommunication handshake may include but is not limited to a transmission control protocol (TCP), simple mail transfer protocol (SMTP), transport layer security (TLS), Wi-Fi protected access (WPA), and the like.

With continued reference to FIG. 1, a security baseline parameter 124 may include capturing using audiovisual capture device 120 a baseline audiovisual measurement. A baseline audiovisual measurement may include measuring any motion and/or sound in a room where a user client device 116 is located. For example, a baseline audiovisual measurement may capture a sound recording, containing background noise in a user's office, where a user is sitting. A baseline audiovisual measurement may include capturing one or more audio and/or visual recordings that identify a user, such as by capturing a picture of a user's face, or an audio recording of a user speaking, to capture a measurement of the user's voice. A baseline audiovisual measurement may include measuring any landmarks located in a space where a user is located. For example, a baseline audiovisual measurement may capture a grandfather clock that is located behind a couch where a user is sitting, in the user's living room. In an embodiment, a baseline audiovisual measurement may be captured, by transmitting to the user one or more user commands, to capture a specific baseline audiovisual measurement. For example, computing device 104 may display instructions on display interface 112 that direct a user to capture a visual scan of the room where the user is located, using audiovisual capture device 120. Information pertaining to a security baseline parameter 124 may be stored within security database 128.

With continued reference to FIG. 1, a security baseline parameter 124 may include establishing secure logon credentials for user client device 116 and/or computing device 104, such for example including a multi-factor authentication method. A multi-factor authentication method is a method in which a user is granted access to a device, such as computing device 104 and/or user client device 116, only after successfully presenting two or more factors to an authentication mechanism. As used herein, an “authentication factor” is a data structure utilized to confirm a user's identify. A factor may include a knowledge factor that require a user to prove specific knowledge, in order to authenticate the user's identify. A knowledge factor may include a password, a personal identification number (PIN), a secret question, and the like. A factor may include a possession factor, that requires a user to retain possession of an item, in order to authenticate the user's identify. A possession factor may include for example a disconnected token, a connected token, and/or a software token. A factor may include an inherent factor which may include a factor uniquely associated with a user. An inherent factor may include one or more biometric measurements such as for example a fingerprint, a face, a voice, and/or an iris recognition. An inherent factor may include a behavioral biometric such as a measurement of a user's gait, or a keystroke dynamic. A factor may include a location based factor that involves identifying the physical location of a user. A multi-factor authentication method may include two-factor authentication where a user's identification may be identified by using two different factors such as something the user knows such as a password, something the user has such as a physical card, and/or something that the user is, such as a biometric measurement including facial recognition or an iris scan. A multi-factor authentication method may include a two-step verification and/or two-step authentication that may confirm a user's identity by using two different factors to authenticate the user's identity, such as for example a password and a code transmitted to a user at a second device, such as a code sent to a mobile device on a short message service (SMS). In some embodiments, establishing security baseline parameter 124 includes receiving from user client device 116 a plurality of authentication factors. In some embodiments, user client device 116 may transmit a plurality of authentication factors to computing device 104. In some embodiments, user client device 116 may transmit a plurality of authentication factors to a separate computing device which may authenticate user client device 116 and transmit a data structure to computing device 104 indicating that user client device 116 has been authenticated.

With continued reference to FIG. 1, computing device 104 establishes a security baseline parameter 124 by identifying a network parameter. A network parameter may include data specifying information relating to any computing devices that are in communication with user client device 116 and/or computing device 104. For example, a network parameter may include establishing traffic level through a local network for a defined period of time, prior to and/or currently with initiating a secure communication channel interface between user client device 116 and computing device 104. Traffic level on a network may be measured by sniffing using a packet analyzer that intercepts and logs traffic that passes over a digital network and/or part of a network. A packet analyzer may include intercepting and logging traffic. For example, as data streams flow across a network, a packet analyzer may capture each packet, and if needed, decode raw data contained within each packet, to analyze the content, and determine network activity. A packet analyzer may include but is not limited to capsa network analyzer, charles web debugging proxy, carnivore, commview, dSniff, endaceprobe analytics platform, Ettercap, fiddler, kismet, lanmeter, narusInsight, ngrep, omnipeek, skygrabber, snopp, tcpdump, observer analyzer, wireshark, and the like. Computing device 104 may identify a network parameter using other local agents that may measure bandwith use on individual machines and/or routers, including but not limited to simple network management protocol (SNMP), and/or Windows management instrumentation (WMI). For example, a local agent such as an inline appliance may sit between a local area network (LAN) and the LAN's exit point, and capture all packets leaving and/or entering the network. In such an instance, a local agent may be undetectable by other users.

With continued reference to FIG. 1, computing device 104 may establish a security baseline parameter 124 by determining a geolocation of user client device 116 as a function of geolocation of computing device 104. As used herein, a “geolocation” of a device is a geographical position of the device. A geolocation may be determined using a global position system (GPS). A geolocation may be identified using a description of the latitude and/or longitude of a position where user client device 116 and/or computing device 104 is located. A geolocation may be obtained based on an input received from user client device 116. Computing device 104 may utilize a geolocation of user client device 116 to determine where user client device 116 is located in reference to computing device 104. For example, computing device 104 may determine that user client device 116 is located in San Diego, California, while computing device 104 is located approximately five hundred miles away in San Francisco, California. In an embodiment, computing device 104 may evaluate multiple inputs containing geolocation data, to obtain an average measurement as to how far away user client device 116 is from computing device 104. For example, computing device 104 may determine that user client device 116 on average is located within a fifty mile radius of computing device 104.

With continued reference to FIG. 1, computing device 104 may be configured to detect a change in a security baseline parameter 124 wherein detecting a change in a security baseline parameter 124 includes detecting a change in relation to a baseline user environment landmark. A change in a security baseline parameter 124 includes any deviation from the security baseline parameter. Computing device 104 is configured to detect a physical intrusion using audiovisual capture device 120. A physical intrusion includes any person and/or object entering into a restricted area, where a user may be located. For example, a security baseline parameter 124 may include a video scan of a user's living room, where a user is sitting. In such an instance, a change in a security baseline parameter 124 may include a physical intrusion such as when a user's spouse walk in the living room and is captured by audiovisual capture device 120. A physical intrusion may include an object entering a restricted area, such as a user who is seated in front of a window, and an object such as a curtain falls off the window and is captured by audiovisual capture device 120. In yet another non-limiting example, a change in relation to a baseline user environment landmark may include determining that a desk captured in a security baseline parameter is no longer captured by audiovisual capture device 120, and instead the user is located in a different environment, such as the user's kitchen. In yet another non-limiting example, a change in relation to a baseline user environment landmark may indicate that a human being is blocking a baseline user environment landmark, such as a user's spouse who accidentally entered a room where a user is located and is physically blocking the user.

With continued reference to FIG. 1, computing device 104 may be configured to detect a change in a security baseline parameter 124, including a change in an optically detected motion level. An optically detected motion level may include any measurement of displacement, distance, velocity, acceleration, speed, and/or time. An optically detected motion level may be measured as applied to objects, human bodies, animals, matter particles, matter fields, radiation, radiation particles, and the like. Motion levels may be detected based on one or more measurements of momentum. An optically detected motion level may be measured using a discrete cosine transformation (DCT), which expresses a finite sequence of data points in terms of a sum of cosine functions oscillating at various frequencies. DCT expresses a function or a signal in terms of a sum of sinusoids with different frequencies and amplitudes. A DCT operates on a function at a finite number of discrete data points. A DCT may separate an image, including any audio and/or visual image captured by audiovisual capture device 120 and separate the image into parts including spectral sub-bands, of differing importance. A DCT may transform a signal or image from a spatial domain to a frequency domain. A DCT may take an image and/or signal and break the image and/or signal into 8×8 blocks of pixels. Working from left to right, and top to bottom, the DCT is applied to each block. Each block may then be compressed through quantization, and the array of compressed blocks that constitute the original image and/or signal are stored in a drastically reduced amount of space. The image and/or signal may be reconstructed decompression, which may include using inverse discrete cosine transformation (IDCT). A DCT may be utilized to obtain and/or determine changes in optical motion, as compared to one or more security baseline parameters 124.

With continued reference to FIG. 1, computing device 104 may be configured to detect a change in a security baseline parameter 124 including detecting a change in local network traffic. A change in local network traffic may include any change in a network parameter, such as, for example, increased local network traffic. For example, a packet analyzer, including any of the packet analyzers as described above in more detail, may detect increased network traffic, and a great number of devices connecting to a local network that user client device 116 and computing device 104 are both connected to. A change in local network traffic may include determining that a secondary device is attempting to communicate with user client device 116, such as an unexpected Bluetooth pairing, a hotspot linking, and the like. A change in local network traffic may also include an indication that network traffic is being diverted such as to a particular network or away from a particular network. Computing device 104 is configured to detect other various changes in security including for example any changes in lighting in the background of computing device 104 and/or user client device 116, aberrations, changes in geometrics, critical file changes, unusually slow network or devices, obvious device tampering, locked user accounts, unusual outbound traffic, abnormal administrative user activity, and/or any sharp difference in audio that would suggest a security breach in a video-audio appointment.

With continued reference to FIG. 1, computing device 104 may be configured to execute a mitigation action to prevent a security breach. A “mitigation action,” as used in this disclosure, is an action intended to cure a change in security. A cure may include one or more actions, intended to correct a security breach. A security breach may occur when an intruder gains unauthorized access to secure communication channel 108 between user client device 116 and computing device 104. A mitigation action includes displaying within secure communication channel 108 a warning message. A warning message may contain one or more characters, symbols, and/or text, indicating that suspicious activity has been detected. Computing device 104 transmits to user client device 116 a new configuration packet and authenticates the security of user client device 116 as a function of the new configuration packet. Transmitting a new configuration packet may include stopping communications through secure communication channel interface 108 and initiating a new secure communication channel interface 108 once the security of user client device 116 has been authenticated. In some embodiments, computing device 104 may request from user client device 116 a plurality of authentication factors as a function of a change in the security baseline parameter. In some embodiments, computing device 104 may alert a security professional as a function of a change in security baseline parameter. For example, computing device 104 may transmit a security alert datum to a computing device operated by a security professional. As used herein, a “security alert datum” is a data structure generated by a first computing device as a function of a change in a security baseline parameter, a departure from a security baseline parameter, or both, where the data structure is subsequently transmitted to a second computing device. A security professional may include, for example, a cybersecurity professional.

With continued reference to FIG. 1, a mitigation action includes pausing the initiation of secure communication channel interface 108 as a function of detecting a change in security. Pausing may include temporarily suspending and/or stopping secure communication channel interface 108. Computing device 104 confirms the security of user client device 116 and computing device 104 and reinitiates secure communication channel interface 108. Confirming the security of user client device 116 may include establishing a second security baseline parameter 124, using any of the methodologies as described above in more detail.

With continued reference to FIG. 1, computing device 104 is configured to detect a new program session on user client device 116. A “new program session,” as used in this disclosure, is an application other than system 100 that is running and/or initiated on user client device 116. A new program session may include for example, a word processor, a game program, a spreadsheet, a database system, a graphics program, a web browser, and the like. Computing device 104 detects a new program while secure communication channel interface 108 has been initiated, and computing device 104 is in communication with user client device 116. Computing device 104 disables a new program session. Disabling a new program session includes blocking and/or suspending a new program session until communications between user client device 116 and computing device 104 have been completed, and secure communication channel interface 108 has been disabled.

Still referring to FIG. 1, computing device 104 may identify a user health datum. In some embodiments, computing device 104 may identify a user health datum as a function of security baseline parameter 124. As used herein, a “user health datum” is a health record, a data structure describing a synchronous communication between a user of a computing device and a user of a user client device, or both. In some embodiments, computing device 104 may share a health record using secure communication channel interface 108. As used herein, a “health record” is a data structure describing a medical status of a subject, a medical history of a subject, a medical event of a subject, a medical datum of a subject, or a combination thereof. In non-limiting examples, a health record may include a data structure describing a medical procedure performed on a subject, results of a medical test performed on a subject and/or a sample extracted from a subject, and historical notes of a doctor meeting with a subject. As used herein, a first computing device “shares” a health record when the first computing device receives the health record from a second computing device, communicates the health record to the second computing device, or both. In a non-limiting example, computing device 104 may communicate a health record to user client device 116. In some embodiments, computing device 104 may identify a user health datum as a function of security baseline parameter 124 and/or a degree of deviation from security baseline parameter 124. In a non-limiting example, computing device 104 does not identify a user health datum if security baseline parameter 124 and/or a degree of deviation from security baseline parameter 124 indicates that security of secure communication channel interface 108 and/or a computing device connected using secure communication channel interface 108 is compromised. Identifying a user health datum may include, as examples, locating a user health datum in computer memory, selecting a user health datum of interest from a set of user health data (such as based on user input), and/or retrieving a user health datum from a database. In some embodiments, a mitigation action may include pausing, closing, and/or terminating secure communication channel interface 108. In some embodiments, a mitigation action may include not identifying a user health datum and/or a health record. In some embodiments, a mitigation action may include not transmitting a health record using secure communication channel interface 108. In some embodiments, a mitigation action may include not transmitting an attempted communication of a user using secure communication channel interface 108.

Still referring to FIG. 1, user client device 116 and/or computing device 104 may transmit audio information over secure communication channel interface 108. For example, user client device 116 and/or computing device 104 may transmit audio information of synchronous communications such as verbal communications between users of user client device 116 and computing device 104 over secure communication channel interface 108. In some embodiments, computing device 104 may transcribe audio information transmitted over secure communication channel interface 108. In some embodiments, audio information may include a data structure which may be read by a computing device and interpreted to output sound to a user, such as through use of a speaker. Transcription of audio information over secure communication channel interface 108 includes transcription by computing device 104 of audio information recorded by a microphone of computing device 104, where such audio information is also transmitted by computing device 104 to user client device 116 over secure communication channel interface 108. Transcription of audio information over secure communication channel interface 108 includes receipt of audio information by computing device 104 from user client device 116 over secure communication channel interface 108, and subsequent transcription of such audio information.

Still referring to FIG. 1, in some embodiments, audio information may be processed and/or transcribed using automatic speech recognition. In some embodiments, automatic speech recognition may require training (i.e., enrollment). In some cases, training an automatic speech recognition model may require an individual speaker to read text or isolated vocabulary. In some cases, training data may include an audio component having an audible verbal content, the contents of which are known a priori by a computing device. Computing device may then train an automatic speech recognition model according to training data which includes audible verbal content correlated to known content. In this way, computing device may analyze a person's specific voice and train an automatic speech recognition model to the person's speech, resulting in increased accuracy. Alternatively, or additionally, in some cases, computing device may include an automatic speech recognition model that is speaker independent. As used in this disclosure, a “speaker independent” automatic speech recognition process is an automatic speech recognition process that does not require training for each individual speaker. Conversely, as used in this disclosure, automatic speech recognition processes that employ individual speaker specific training are “speaker dependent.”

Still referring to FIG. 1, in some embodiments, an automatic speech recognition process may perform voice recognition or speaker identification. As used in this disclosure, “voice recognition” is a process of identifying a speaker, from audio content, rather than what the speaker is saying. In some cases, computing device may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within audio information, but others may speak as well.

Still referring to FIG. 1, in some embodiments, an automatic speech recognition process may include one or all of acoustic modeling, language modeling, and statistically based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 1, an exemplary algorithm employed in automatic speech recognition may include or even be based upon hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 1, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 1, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum a posteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 1, in some embodiments, speech (i.e., audible verbal content) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighted by their estimated probability. In some cases, an employed loss function may include Levenshtein distance, although different distance calculations may be performed, for instance for specific tasks. In some cases, a set of candidates may be pruned to maintain tractability.

Still referring to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics—indeed, any data that can be turned into a linear representation can be analyzed with DTW. In some cases, DTW may be used by an automatic speech recognition process to cope with different speaking (i.e., audible verbal content) speeds. In some cases, DTW may allow computing device to find an optimal match between two given sequences (e.g., time series) with certain restrictions. That is, in some cases, sequences can be “warped” non-linearly to match each other. In some cases, a DTW-based sequence alignment method may be used in context of hidden Markov models.

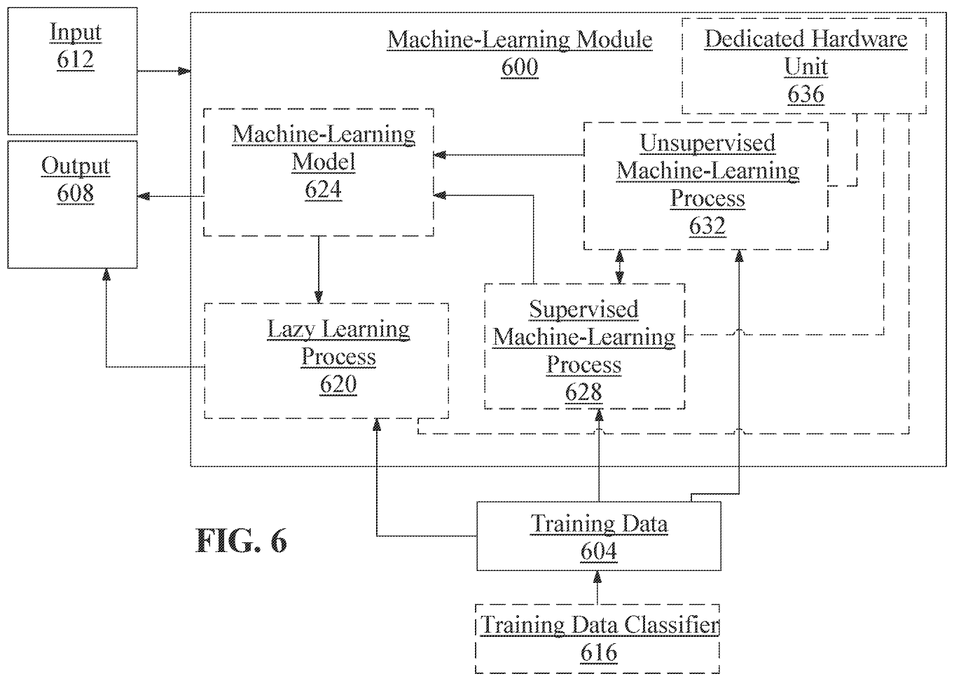

Still referring to FIG. 1, in some embodiments, an automatic speech recognition process may include a neural network. Neural network may include any neural network, for example those disclosed with reference to FIGS. 6-8. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases, neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time interval, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

Still referring to FIG. 1, in some embodiments, computing device 104 may identify a corruption datum corresponding to a health record and delete the health record as a function of the corruption datum. As used herein, a “corruption datum” is a data structure indicating whether a health record, a data structure associated with a health record, or both, is corrupted, the degree to which a health record, a data structure associated with a health record, or both, is corrupted, or both. A health record and/or other data structure may be corrupted when the health record and/or other data structure includes one or more errors, such as an error in recording and/or transmission of a file. Corruption may be detected using, in a non-limiting example, error correcting codes.

Still referring to FIG. 1, in some embodiments, computing device 104 may delete a health record upon secure communication channel interface 108 closing and/or terminating. For example, computing device 104 may delete a health record from computer memory associated with computing device 104 upon secure communication channel interface closing and/or terminating. A secure communication channel interface may close and/or terminate when, for example, one or more users exit an application mediating such channel. In some embodiments, computing device 104 may consider secure communication channel interface to have closed and/or terminated if computing device 104 receives from user client device 116 a data structure indicating that user client device 116 is ending communication over the secure communication channel interface. In some embodiments, computing device 104 may consider secure communication channel interface to have closed and/or terminated if user client device 116 becomes unresponsive over the secure communication channel interface.

Still referring to FIG. 1, in some embodiments, computing device 104 may receive from the user client device a recorded session datum. As used herein, a “recorded session datum” is a data structure describing a prior synchronous communication between a user and a medical professional. In some embodiments, a recorded session datum may include an audio recording. In some embodiments, a recorded session datum may include a transcript of an audio recording. Such a transcript of an audio recording may be produced, in a non-limiting example, through use of an automatic speech recognition system as described herein. In some embodiments, user client device 116 may be configured to generate a recorded session datum as a function of a synchronous communication between a user and a medical professional, such as a communication using a communication channel described herein. In some embodiments, a recorded session datum may be stored in a database and/or retrieved from the database by user client device 116. In some embodiments, an operator of user client device 116 may be given the option to choose which, if any, recorded session data is transmitted to computing device 104 by user client device 116. In some embodiments, an operator of computing device 104 may request a recorded session datum from user client device 116 and/or an operator of user client device 116.

Still referring to FIG. 1, in some embodiments, computing device 104 may transmit a health record to a health record database. In some embodiments, user client device 116 may transmit a health record to a health record database. As used herein, a “health record database” is a database which stores electronic health records. Transmission of a health record to a health record database may include updating a health record of the health record database and/or creating a new health record in the health record database. In some embodiments, a health record may be created as a function of information communicated over secure communication channel interface 108; in some embodiments, a health record created in this way may be transmitted to a health record database.

Still referring to FIG. 1, in some embodiments, computing device 104 may receive from the user client device a health record validation datum. As used herein, a “health record validation datum” is a data structure indicating the accuracy of a health record. For example, a health record may be created as a function of a device worn by a user, such as a device which records physical activity of the user. Computing device 104 may receive such a health record directly from such a device, from user client device 116, and/or from a server associated with such a device. User client device 116 may prompt a user operating user client device 116 to indicate whether or not such a health record is accurate. User client device 116 may transmit to computing device 104 health record validation datum as a function of input of a user. In additional examples, computing device 104 may receive a health record validation datum associated with a health record generated by a different source, such as a smartphone app, a smartwatch app, a web based program, or the like. Health records generated by such programs may include, in non-limiting examples, health records which include physical activity of a user, diet of a user, sleep of a user, and the like.

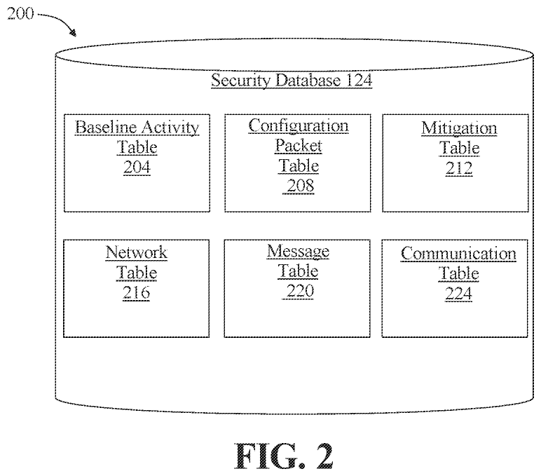

Referring now to FIG. 2, an exemplary embodiment 200 of security database 124 is illustrated. Security database 124 may be implemented as any data structure suitable for use as described above in more detail in reference to FIG. 1. One or more tables contained within security database 124 may include baseline activity table 204; baseline activity table 204 may include one or more security baseline parameters 124. One or more tables contained within security database 124 may include configuration packet table 208; configuration packet table 208 may include information relating to one or more configuration packets 132. One or more tables contained within security database 124 may include mitigation table 212; mitigation table 212 may include information relating to one or more mitigation actions 136. One or more tables contained within security database 124 may include network table 216; network table 216 may include information relating to one or local networks and/or one or more network parameters. One or more tables contained within security database 124 may include encryption table 220; encryption table 220 may include information relating to encryption algorithm and/or encryption techniques. One or more tables contained within security database 124 may include communication table 224; communication table 224 may include information relating to a communication exchange.

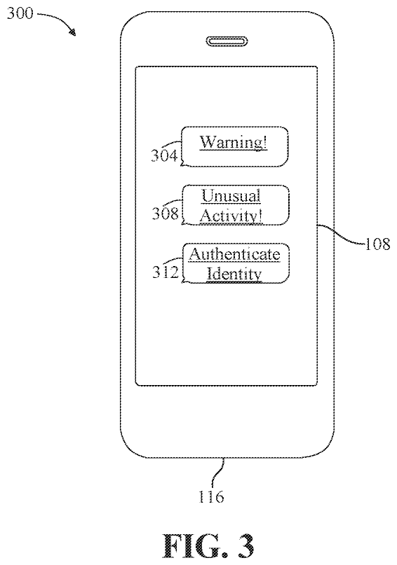

Referring now to FIG. 3, an exemplary embodiment 300 of secure communication channel interface 108 is illustrated. Secure communication channel interface 108 may be implemented as any structure as described above in more detail in reference to FIG. 1. In an embodiment, secure communication channel interface 108 may be displayed using display interface 112 on user client device. In an embodiment, communication channel interface 108 may display a warning message upon detecting a change in security. For example, secure communication channel interface 108 may display a first message 304 “Warning!” Communication channel interface 108 may display a second message 308 providing a rationale or reason for the first message 304, where the second message 308 may state “Unusual Activity!” Communication channel interface 108 may display a third message 312 prompting user client device 116 to “authenticate identity.” User client device 116 may authenticate identify such as by being transmitted a new configuration packet to authenticate. In yet another non-limiting example, user client device 116 may authenticate identity of user client device 116 by establishing a new security baseline parameter 124, utilizing any of the methodologies as described above in more detail in reference to FIG. 1.

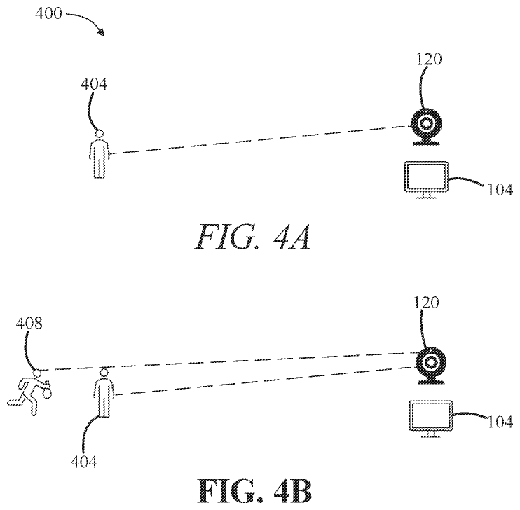

Referring now to FIGS. 4A-4B, an exemplary embodiment of a system 400 of detecting a change in security is illustrated. Referring to FIG. 4A, audiovisual capture device 120, captures a baseline audiovisual measurement of a user 404. A baseline audiovisual measurement 124 may include detecting levels of motion and/or sound in a room where user 404 is located, while waiting for a videoconference appointment to begin, for example. A baseline audiovisual measurement 124 may include using audiovisual capture device 120 to capture one or more images of a user 404, such as by taking a picture or video of a user's entire body, face, and/or one or more distinguishing features. Information relating to a baseline audio visual measurement may be stored within security database 128 as described above in more detail in reference to FIGS. 1-3. Referring now to FIG. 4B, audiovisual capture device 120 detects a change in security, as a function of a security baseline parameter 124. For example, audiovisual capture device 120 and/or computing device 120 may detect a physical intrusion, such as when a bad actor 408 may unexpectedly enter a room where user 404 is located. In such an instance, computing device 104 executes a mitigation action 136 to prevent a security breach caused by bad actor 408. For example, a mitigation action 136 may include temporarily suspending secure communication channel interface 108 and asking user 404 to re-enter credentials before resuming secure communication channel interface 108. A mitigation action 136 may include any of the mitigation actions 136 as described above in more detail in reference to FIG. 1.

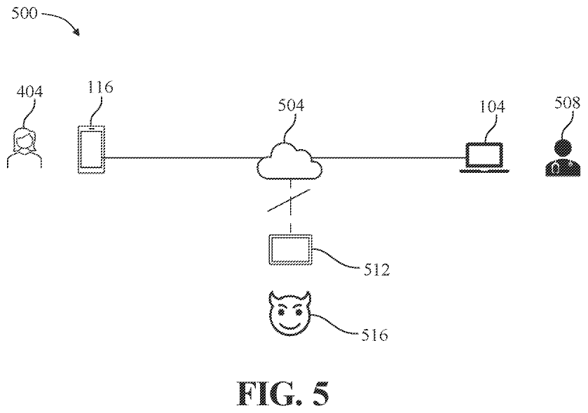

Referring now to FIG. 5, an exemplary embodiment of a system 500 of detecting a change in local network traffic is illustrated. Computing device 104 establishes a security baseline parameter 124 such as by identifying a network parameter. A network parameter includes any of the network parameters ad described above in more detail in reference to FIG. 1. For example, a network parameter may include information relating to any computing devices that are in communication with user client device 116 and/or computing device 104. For instance and without limitation, a network parameter may measure traffic level on a network 504 such as by sniffing using a packet analyzer that intercepts and logs traffic that passes over a digital network 504 and/or part of a network 504, as described above in more detail in reference to FIG. 1. For example, a network parameter may indicate that user client device 116, operated by user 404 and computing device 104 operated by second user 508, such as a medical doctor, are both connected to network 504 and utilizing network 504 to initiate secure communication channel interface 108 to enable a telemedicine appointment. Computing device 104 utilizes network parameters, to detect any changes in local network traffic, such as when a third device 512 operated by a malicious user 516, attempts to joint network 504, and intercept information exchanged with secure communication channel interface 108. In such an instance, a change in local network traffic prompts computing device 104 to execute a mitigation action 136, such as by eliciting an early warning detection message, and displaying the message on display interface 112. In such an instance, computing device 104 may prompt user 404 to re-enter credentials, to resume a telemedicine appointment with second user 508.

Referring now to FIG. 6, an exemplary embodiment of a machine-learning module 600 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 604 to generate an algorithm instantiated in hardware or software logic, data structures, and/or functions that will be performed by a computing device/module to produce outputs 608 given data provided as inputs 612; this is in contrast to a non-machine learning software program where the commands to be executed are determined in advance by a user and written in a programming language.

Still referring to FIG. 6, “training data,” as used herein, is data containing correlations that a machine-learning process may use to model relationships between two or more categories of data elements. For instance, and without limitation, training data 604 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 604 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 604 according to various correlations; correlations may indicate causative and/or predictive links between categories of data elements, which may be modeled as relationships such as mathematical relationships by machine-learning processes as described in further detail below. Training data 604 may be formatted and/or organized by categories of data elements, for instance by associating data elements with one or more descriptors corresponding to categories of data elements. As a non-limiting example, training data 604 may include data entered in standardized forms by persons or processes, such that entry of a given data element in a given field in a form may be mapped to one or more descriptors of categories. Elements in training data 604 may be linked to descriptors of categories by tags, tokens, or other data elements; for instance, and without limitation, training data 604 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 6, training data 604 may include one or more elements that are not categorized; that is, training data 604 may not be formatted or contain descriptors for some elements of data. Machine-learning algorithms and/or other processes may sort training data 604 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 604 to be made applicable for two or more distinct machine-learning algorithms as described in further detail below. Training data 604 used by machine-learning module 600 may correlate any input data as described in this disclosure to any output data as described in this disclosure. As a non-limiting illustrative, inputs may include audio data and outputs may include a text transcript of the audio data.

Further referring to FIG. 6, training data may be filtered, sorted, and/or selected using one or more supervised and/or unsupervised machine-learning processes and/or models as described in further detail below; such models may include without limitation a training data classifier 616. Training data classifier 616 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 600 may generate a classifier using a classification algorithm, defined as a processes whereby a computing device and/or any module and/or component operating thereon derives a classifier from training data 604. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 616 may classify elements of training data to particular words or phonetic elements.

With further reference to FIG. 6, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 6, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 6, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 6, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 6, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 6, machine-learning module 600 may be configured to perform a lazy-learning process 620 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 604. Heuristic may include selecting some number of highest-ranking associations and/or training data 604 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 6, machine-learning processes as described in this disclosure may be used to generate machine-learning models 624. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 624 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 624 may be generated by creating an artificial neural network, such as a convolutional neural network comprising an input layer of nodes, one or more intermediate layers, and an output layer of nodes. Connections between nodes may be created via the process of “training” the network, in which elements from a training data 604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 6, machine-learning algorithms may include at least a supervised machine-learning process 628. At least a supervised machine-learning process 628, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include audio data as described above as inputs, a transcript of the audio data as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 604. Persons skilled in the art, upon reviewing the entirety of this disclosure, will be aware of various possible variations of at least a supervised machine-learning process 628 that may be used to determine relation between inputs and outputs. Supervised machine-learning processes may include classification algorithms as defined above.

With further reference to FIG. 6, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 6, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 6, machine learning processes may include at least an unsupervised machine-learning processes 632. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 632 may not require a response variable; unsupervised processes 632 may be used to find interesting patterns and/or inferences between variables, to determine a degree of correlation between two or more variables, or the like.

Still referring to FIG. 6, machine-learning module 600 may be designed and configured to create a machine-learning model 624 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 6, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 6, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 6, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 6, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 6, one or more processes or algorithms described above may be performed by at least a dedicated hardware unit 636. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 636 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 636 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 636 to perform one or more operations described herein, such as evaluation of model and/or algorithm outputs, one-time or iterative updates to parameters, coefficients, weights, and/or biases, and/or any other operations such as vector and/or matrix operations as described in this disclosure.

With continued reference to FIG. 6, system 100 may use user feedback to train the machine-learning models and/or classifiers described above. For example, classifier may be trained using past inputs and outputs of classifier. In some embodiments, if user feedback indicates that an output of classifier was “bad,” then that output and the corresponding input may be removed from training data used to train classifier, and/or may be replaced with a value entered by, e.g., another user that represents an ideal output given the input the classifier originally received, permitting use in retraining, and adding to training data; in either case, classifier may be retrained with modified training data as described in further detail below. In some embodiments, training data of classifier may include user feedback.

With continued reference to FIG. 6, in some embodiments, an accuracy score may be calculated for classifier using user feedback. For the purposes of this disclosure, “accuracy score,” is a numerical value concerning the accuracy of a machine-learning model. For example, a plurality of user feedback scores may be averaged to determine an accuracy score. In some embodiments, a cohort accuracy score may be determined for particular cohorts of persons. For example, user feedback for users belonging to a particular cohort of persons may be averaged together to determine the cohort accuracy score for that particular cohort of persons and used as described above. Accuracy score or another score as described above may indicate a degree of retraining needed for a machine-learning model such as a classifier; system 100 may perform a larger number of retraining cycles for a higher number (or lower number, depending on a numerical interpretation used), and/or may collect more training data for such retraining, perform more training cycles, apply a more stringent convergence test such as a test requiring a lower mean squared error, and/or indicate to a user and/or operator that additional training data is needed.

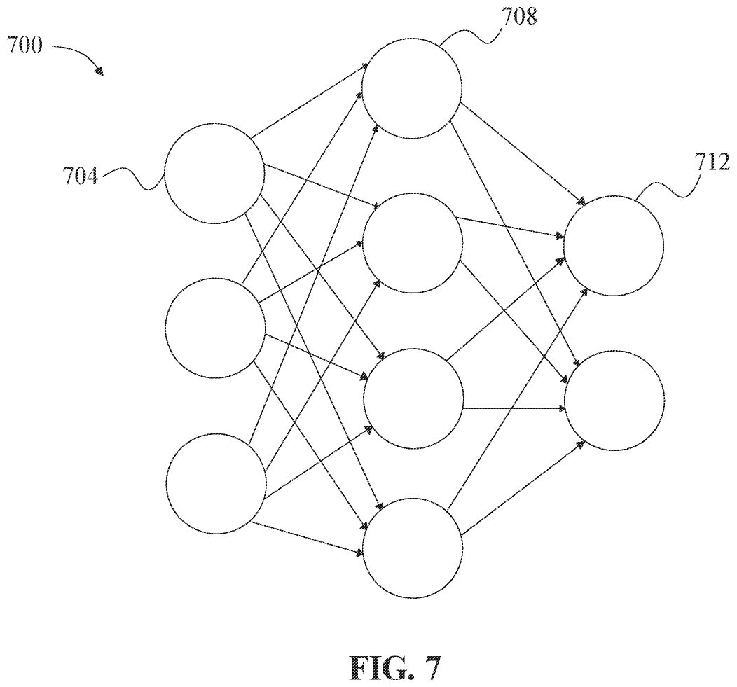

Referring now to FIG. 7, an exemplary embodiment of neural network 700 is illustrated. A neural network 700 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 704, one or more intermediate layers 708, and an output layer of nodes 712. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

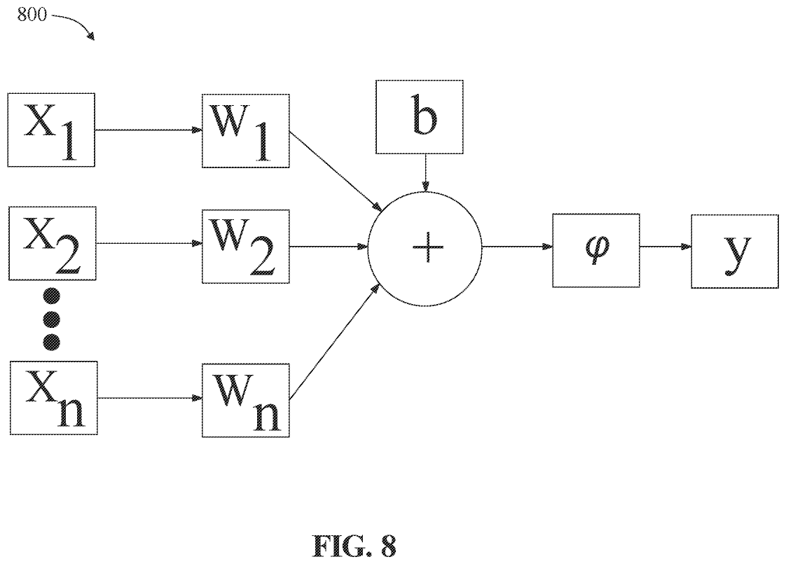

Referring now to FIG. 8, an exemplary embodiment of a node 800 of a neural network is illustrated. A node may include, without limitation a plurality of inputs x; that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh² (x), a rectified linear unit function such as f (x)=max(0, x), a “leaky” and/or “parametric” rectified linear unit function such as f (x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(\sqrt{2/π}(x+bx^{r}))) for some values of a, b, and r, and/or a scaled exponential linear unit function such as

$$f ( x ) = \{ \begin{matrix}α ( {e}^{x} - 1 ) for x < 0 \\ x for x \geq 0\end{matrix} .$$

Fundamentally, there is no limit to the nature of functions of inputs x; that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function q, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

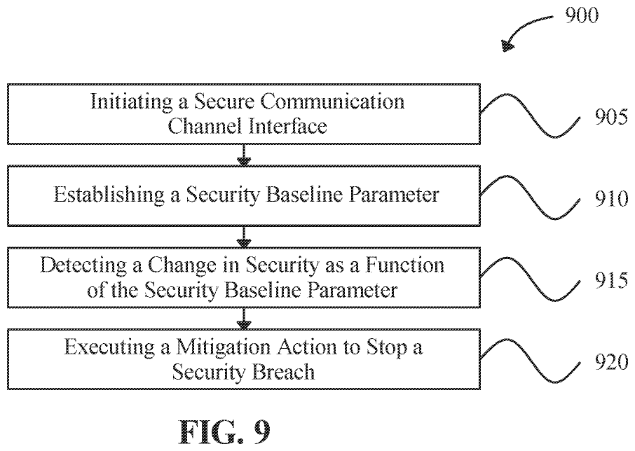

Referring now to FIG. 9, an exemplary embodiment 900 of a method of generating a secure communication channel interface for video streaming of sensitive content is illustrated. At step 905, computing device 104 initiates a secure communication channel interface 108 between user client device 116 and computing device 104. Secure communication channel interface 108 includes any of the secure communication channel interfaces as described above in more detail in reference to FIG. 1. A secure communication channel interface 108 may include an application, script, and/or program capable of providing a means of communication between at least two parties, including any oral and/or written forms of communication. A secure communication channel interface 108 may be launched between a user client device 116 operated by a user, and computing device 104 which may be operated by a third party, such as a functional medicine doctor. A secure communication channel interface 108 may be used for example, to accommodate a telemedicine appointment, or to facilitate secure communications between members of a support group, such as users who have a gambling addition or users who are seeking to abstain from one or more addictive practices including but not limited to alcohol, drugs, sex, gambling, medications, shopping, video games, plastic surgery, eating disorders, risky behavior and the like. Secure communication channel interface 108 includes an audiovisual capture device 120, including any of the audiovisual capture devices 120 as described above in more detail in reference to FIG. 1. For instance and without limitation, an audiovisual capture device 120 may include a video camera, a camera, a sensor, a microphone, and the like.

With continued reference to FIG. 9, at step 910, computing device 104 establishes a security baseline parameter 124 within secure communication channel interface 108 wherein establishing the security baseline parameter 124 includes establishing using audiovisual capture device 120, a baseline user environment landmark. Security baseline parameter 124 includes any of the security baseline parameters 124 as described above in more detail in reference to FIG. 1. Establishing a security baseline parameter 124 may include capturing using audiovisual capture device 120, a baseline audiovisual measurement. A baseline audiovisual measurement may include using audiovisual capture device 120 to scan a room where a user may be located, including a room where a user is located using user client device 116 and including a room where an operator of computing device 104 may be located, such as a functional medicine doctor. For example, a baseline audio visual measurement may capture video footage of a user sitting in a bedroom in the user's house, and video footage of a nurse practitioner sitting in the nurse practitioner's office, so that the user and the nurse practitioner may engage in a secure communication exchange. Information pertaining to a security baseline parameter may be stored within security database 124, as described above in more detail in reference to FIG. 1.

With continued reference to FIG. 9, establishing a security baseline parameter 124 includes identifying a network parameter. A network parameter includes any of the network parameters as described above in more detail in reference to FIG. 1. A network parameter may include measuring traffic levels through a local network for a defined period of time, prior to allowing a connection to join the local network. A network parameter may be measured by sniffing using a packet analyzer, as described above in more detail in reference to FIG. 1. Establishing a security baseline parameter may include determining a geolocation of a user client device 116 as a function of a geolocation of computing device 104. A geolocation of user client device 116 and/or computing device 104 may be determined using any of the methodologies as described above in more detail in reference to FIG. 1. For instance and without limitation, computing device 104 may match a geolocation of user client device 116 to geolocation of computing device 104 operated by a physician located at a hospital three miles away.

With continued reference to FIG. 9, at step 915, computing device 104 detects a change in security as a function of a security baseline parameter 124 wherein detecting the change in security comprises detecting a change in relation to the baseline user environment landmark. Computing device 104 detects a change in security utilizing any of the methodologies as described above in more detail in reference to FIG. 1. Detecting a change in security includes detecting a physical intrusion using audiovisual capture device 120. For instance and without limitation, audiovisual capture device 120 may detect a physical intrusion such as a nurse who may enter a doctor's office while a doctor is communicating with a patient through secure communication channel interface 108. In yet another non-limiting example, audiovisual capture device 120 may detect a physical intrusion such as an object that may shift or move behind a user in a room. Detecting a change in security may include detecting a change in an optically detected motion level. A change in an optically detected motion level may be measured using DCT of a video feed as described above in more detail in reference to FIG. 1. Detecting a change in security may include detecting a change in local network traffic, including any traffic that is diverted to or from a network, detecting new devices that may attempt to join a network and the like. Detecting a change in security may include detecting any lighting aberrations, changes in geometries, or sharp differences in audio that would suggest a security breach during utilization of secure communication channel interface 108. Detecting a change in security may include detecting any attempts by secondary devices to communicated with user client device 116 and/or computing device 104, such as an unexpected Bluetooth pairing, hot spot linking, and the like.

With continued reference to FIG. 9, at step 920, computing device 104 executes a mitigation action 136 to prevent a security breach. A mitigation action 136 includes any of the mitigation actions as described above in more detail in reference to FIG. 1. A mitigation action may include displaying within secure communication channel interface 108 a warning message. A warning message includes any of the warning messages as described above in more detail in reference to FIG. 1. Computing device 104 may display a warning message on display interface 112. Computing device 104 transmits to user client device 116 a new configuration packet and authenticates the security of user client device as a function of the new configuration packet. This may be performed utilizing any of the methods as described above in more detail in reference to FIG. 1. Computing device 104 authenticates the security of user client device 116 as a function of the new configuration packet. A mitigation action includes pausing the initiation of secure communication channel 108 as a function of detecting a change in security. For example, a user may be discussing the user's alcohol additions with a friend using secure communication channel interface 108. In such an instance, computing device 104 may detect a change in security that identifies an attempt by a third party device to join communications with user and user's friend within secure communication channel interface 108. Computing device 104 pauses the initiation of secure communication channel interface 108 as a function of detecting a change in security and confirms the security of user client device 116 and computing device 104 before reinitiating secure communication channel interface 108. Computing device 104 executes a mitigation action 136 by detecting a new program session on user client device 116. A new program session includes any of the new program sessions as described above in more detail in reference to FIG. 1. For example, a new program session may include preventing more than one simultaneous session using secure communication channel interface 108 by user client device 116. Computing device 104 disables a new program session while secure communication channel interface 108 is in use. For example, computing device 104 may disable user client device 116 capabilities during use of secure communication channel interface 108, where applications such as screenshots, page printing, and screen sharing may be prohibited to protect a user's information from being stolen.

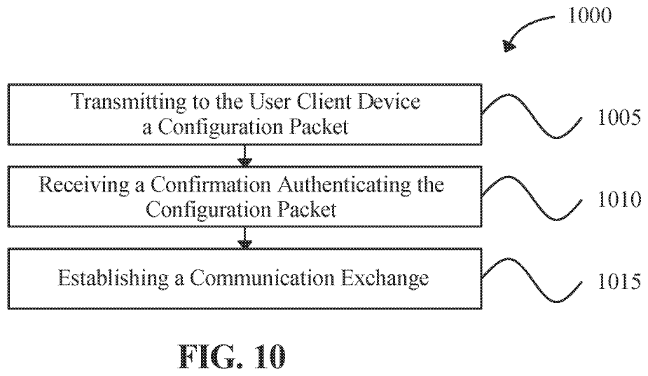

Referring now to FIG. 10, an exemplary embodiment 1000 of establishing by computing device 104 a security baseline parameter within secure communication channel interface is illustrated. At step 1005, computing device 104 transmits to user client device 116 a configuration packet 132 uniquely identifying computing device 104. Configuration packet 132 includes any of the configuration packets 132 as described above in more detail in reference to FIG. 1. In an embodiment, configuration packet 132 may include an encrypted message, containing a non-public device identifier of computing device 104, such as a token and/or passcode. User client device 116 may transmit to computing device 104 a configuration packet 132 for computing device 104 to authenticate. In such an instance, computing device 104 and user client device 116 may each run a command within its own kernel space to decode each message, and then independently accept or deny a configuration packet 132, thereby forming a device handshake. Device handshake may be executed using any of the methodologies as described above in more detail in reference to FIG. 1. This may be performed to aid in preventing any transport layer ports used by secure communication channel interface 108 from being used by any other communication pathway. At step 1010, computing device 104 receives from user client device 116 a confirmation authenticating configuration packet 132. At step 1015, computing device 104 establishes a communication exchange as a function of authenticating configuration packet 132.

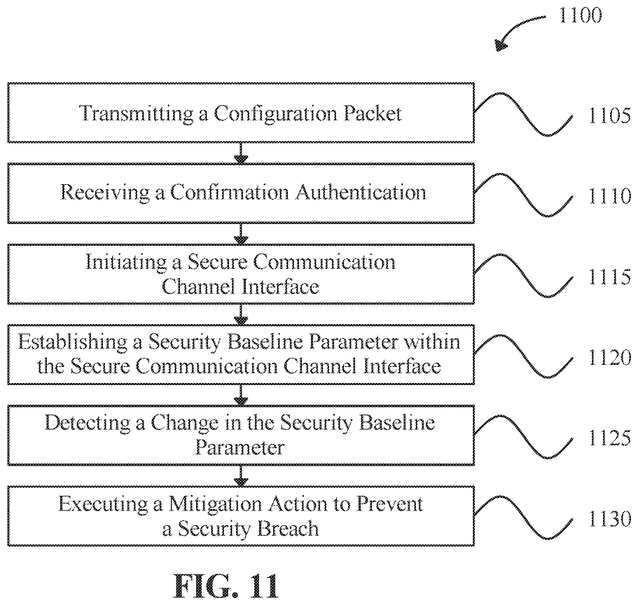

Referring now to FIG. 11, a method 1100 is shown. Method 1100 may be implemented, without limitation, as disclosed with reference to FIGS. 1-10. Method 1100 includes a step 1105 of transmitting, at a computing device and to a user client device, a configuration packet uniquely identifying the computing device. This may be implemented, without limitation, as disclosed with reference to FIGS. 1-10. In some embodiments, the user client device may be operated by a user and the computing device may be operated by a medical professional. In some embodiments, the configuration packet may include a non-public device identifier of the computing device.

With continued reference to FIG. 11, method 1100 includes a step 1110 of receiving, at the computing device and from the user client device, a confirmation authentication for the configuration packet. This may be implemented, without limitation, as disclosed with reference to FIGS. 1-10.

With continued reference to FIG. 11, method 1100 includes a step 1115 of initiating, at the computing device, a secure communication channel interface with the user client device. This may be implemented, without limitation, as disclosed with reference to FIGS. 1-10. In some embodiments, the secure communication channel interface may include a display interface.

With continued reference to FIG. 11, method 1100 includes a step 1120 of establishing, at the computing device, a security baseline parameter within the secure communication channel interface, wherein establishing a security baseline parameter includes capturing a baseline audiovisual measurement using an audiovisual capture device. This may be implemented, without limitation, as disclosed with reference to FIGS. 1-10.

With continued reference to FIG. 11, method 1100 includes a step 1125 of detecting, at the computing device, a change in the security baseline parameter by detecting a change in relation to a baseline user environment landmark. This may be implemented, without limitation, as disclosed with reference to FIGS. 1-10. Step 1125 includes pausing the initiation of the secure communication channel interface as a function detecting the change in security. This may be implemented, without limitation, as disclosed with reference to FIGS. 1-10. Step 1125 includes confirming the security of the user client device and the computing device. This may be implemented, without limitation, as disclosed with reference to FIGS. 1-10. Step 1125 includes reinitiating the secure communication channel. This may be implemented, without limitation, as disclosed with reference to FIGS. 1-10. In some embodiments, the baseline user environment landmark may include a baseline audiovisual measurement. In some embodiments, the baseline user environment landmark may include a network parameter. In some embodiments, the baseline user environment landmark may include a geolocation of the user client device as a function of a geolocation of the computing device.

With continued reference to FIG. 11, method 1100 includes a step 1130 of executing, at the computing device, a mitigation action to prevent a security breach. This may be implemented, without limitation, as disclosed with reference to FIGS. 1-10.

With continued reference to FIG. 11, method 1100 may include a step of displaying, on the display interface, instructions to the user. This may be implemented, without limitation, as disclosed with reference to FIGS. 1-10. In some embodiments, method 1100 may include a step of detecting a new program session on the user client device. This may be implemented, without limitation, as disclosed with reference to FIGS. 1-10. In some embodiments, method 1100 may include disabling the new program session. This may be implemented, without limitation, as disclosed with reference to FIGS. 1-10. In some embodiments, method 1100 may include a step of establishing a communication exchange as a function of receiving the confirmation identification of configuration packet from the user client device. This may be implemented, without limitation, as disclosed with reference to FIGS. 1-10.

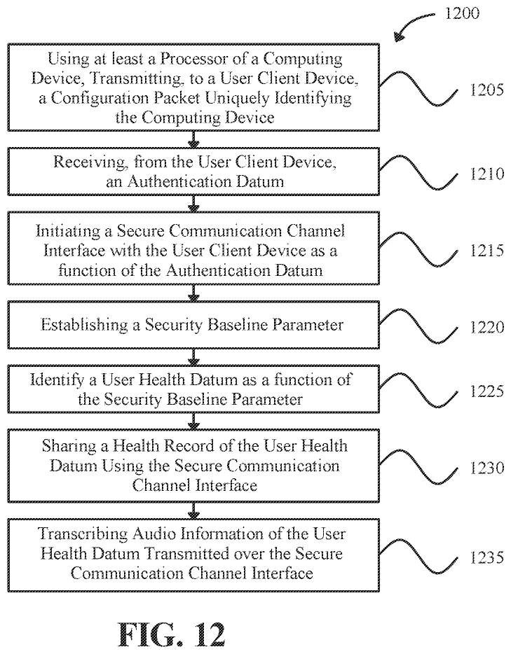

Referring now to FIG. 12, an exemplary embodiment of a method 1200 of generating a secure communication channel interface is illustrated. One or more steps if method 1200 may be implemented, without limitation, as described with reference to other figures. One or more steps of method 1200 may be implemented, without limitation, using at least a processor.

Still referring to FIG. 12, in some embodiments, method 1200 may include, using at least a processor of a computing device, transmitting, to a user client device, a configuration packet uniquely identifying the computing device 1205. In some embodiments, the computing device is operated by a medical professional; and the user client device is operated by a patient of the medical professional.

Still referring to FIG. 12, in some embodiments, method 1200 may include receiving, from the user client device, an authentication datum 1210.

Still referring to FIG. 12, in some embodiments, method 1200 may include initiating a secure communication channel interface with the user client device as a function of authentication datum 1215.

Still referring to FIG. 12, in some embodiments, method 1200 may include establishing a security baseline parameter 1220. In some embodiments, establishing a security baseline parameter may include identifying a network parameter, identifying a baseline audiovisual measurement, identifying a biometric identifier of a user, and/or identifying a user environment landmark includes a physical object. In some embodiments, establishing the security baseline parameter includes receiving from the user client device a plurality of authentication factors.

Still referring to FIG. 12, in some embodiments, method 1200 may include identifying a user health datum as a function of security baseline parameter 1225.

Still referring to FIG. 12, in some embodiments, method 1200 may include sharing a health record of the user health datum using the secure communication channel interface 1230.

Still referring to FIG. 12, in some embodiments, method 1200 may include transcribing audio information of the user health datum transmitted over the secure communication channel interface 1235.

Still referring to FIG. 12, in some embodiments, method 1200 may further include identifying a corruption datum corresponding to the health record and/or deleting the health record as a function of the corruption datum. In some embodiments, method 1200 may further include deleting the health record upon the secure communication channel interface terminating. In some embodiments, method 1200 may further include receiving from the user client device a recorded session datum. In some embodiments, method 1200 may further include requesting from the user client device a plurality of authentication factors as a function of a change in the security baseline parameter. In some embodiments, method 1200 may further include transmitting the health record to a health record database. In some embodiments, method 1200 may further include receiving from the user client device a health record validation datum. In some embodiments, method 1200 may further include receiving from the user client device a health record validation datum as a function of user input. In some embodiments, method 1200 may further include alerting a security professional as a function of a change in the security baseline parameter.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

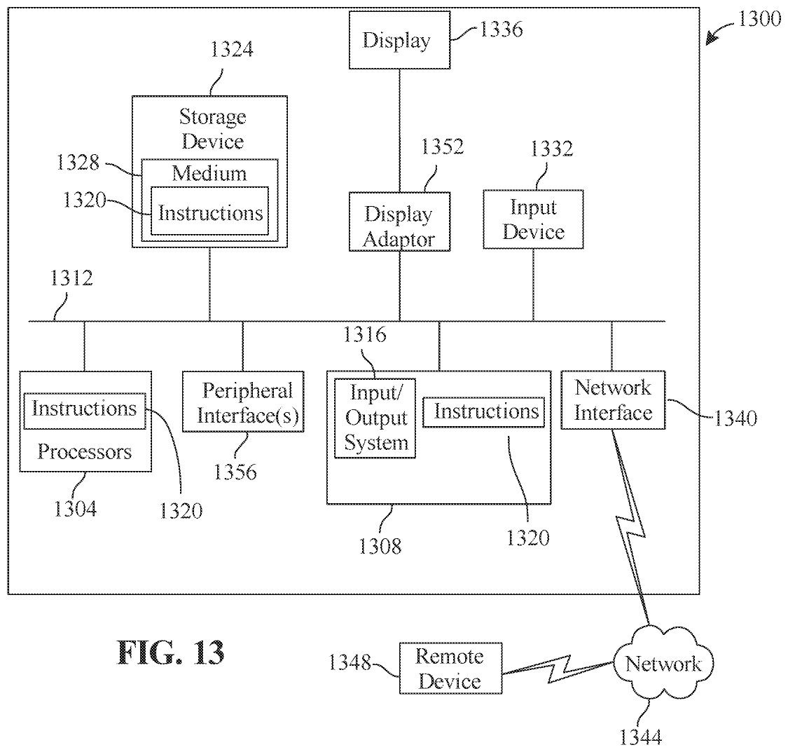

FIG. 13 shows a diagrammatic representation of one embodiment of a computing device in the exemplary form of a computer system 1300 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1300 includes a processor 1304 and a memory 1308 that communicate with each other, and with other components, via a bus 1312. Bus 1312 may include any of several types of bus structures including, but not limited to, a memory bus, a memory controller, a peripheral bus, a local bus, and any combinations thereof, using any of a variety of bus architectures.

Processor 1304 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1304 may be organized according to Von Neumann and/or Harvard architecture as a non-limiting example. Processor 1304 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1308 may include various components (e.g., machine-readable media) including, but not limited to, a random-access memory component, a read only component, and any combinations thereof. In one example, a basic input/output system 1316 (BIOS), including basic routines that help to transfer information between elements within computer system 1300, such as during start-up, may be stored in memory 1308. Memory 1308 may also include (e.g., stored on one or more machine-readable media) instructions (e.g., software) 1320 embodying any one or more of the aspects and/or methodologies of the present disclosure. In another example, memory 1308 may further include any number of program modules including, but not limited to, an operating system, one or more application programs, other program modules, program data, and any combinations thereof.

Computer system 1300 may also include a storage device 1324. Examples of a storage device (e.g., storage device 1324) include, but are not limited to, a hard disk drive, a magnetic disk drive, an optical disc drive in combination with an optical medium, a solid-state memory device, and any combinations thereof. Storage device 1324 may be connected to bus 1312 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1324 (or one or more components thereof) may be removably interfaced with computer system 1300 (e.g., via an external port connector (not shown)). Particularly, storage device 1324 and an associated machine-readable medium 1328 may provide nonvolatile and/or volatile storage of machine-readable instructions, data structures, program modules, and/or other data for computer system 1300. In one example, software 1320 may reside, completely or partially, within machine-readable medium 1328. In another example, software 1320 may reside, completely or partially, within processor 1304.

Computer system 1300 may also include an input device 1332. In one example, a user of computer system 1300 may enter commands and/or other information into computer system 1300 via input device 1332. Examples of an input device 1332 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1332 may be interfaced to bus 1312 via any of a variety of interfaces (not shown) including, but not limited to, a serial interface, a parallel interface, a game port, a USB interface, a FIREWIRE interface, a direct interface to bus 1312, and any combinations thereof. Input device 1332 may include a touch screen interface that may be a part of or separate from display 1336, discussed further below. Input device 1332 may be utilized as a user selection device for selecting one or more graphical representations in a graphical interface as described above.

A user may also input commands and/or other information to computer system 1300 via storage device 1324 (e.g., a removable disk drive, a flash drive, etc.) and/or network interface device 1340. A network interface device, such as network interface device 1340, may be utilized for connecting computer system 1300 to one or more of a variety of networks, such as network 1344, and one or more remote devices 1348 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1344, may employ a wired and/or a wireless mode of communication. In general, any network topology may be used. Information (e.g., data, software 1320, etc.) may be communicated to and/or from computer system 1300 via network interface device 1340.

Computer system 1300 may further include a video display adapter 1352 for communicating a displayable image to a display device, such as display device 1336. Examples of a display device include, but are not limited to, a liquid crystal display (LCD), a cathode ray tube (CRT), a plasma display, a light emitting diode (LED) display, and any combinations thereof. Display adapter 1352 and display device 1336 may be utilized in combination with processor 1304 to provide graphical representations of aspects of the present disclosure. In addition to a display device, computer system 1300 may include one or more other peripheral output devices including, but not limited to, an audio speaker, a printer, and any combinations thereof. Such peripheral output devices may be connected to bus 1312 via a peripheral interface 1356. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for generating a secure communication channel interface, the system comprising a computing device configured to:
transmit, to a user client device, a configuration packet uniquely identifying the computing device;
receive, from the user client device, an authentication datum;
initiate a secure communication channel interface with the user client device as a function of the authentication datum;
establish a security baseline parameter, wherein establishing the security baseline parameter comprises:
identifying a network parameter;
identifying a baseline audiovisual measurement;
identifying a biometric identifier of a user; and
identifying a user environment landmark comprising a physical object;
identify a user health datum as a function of the security baseline parameter;
share a health record of the user health datum using the secure communication channel interface; and
transcribe audio information of the user health datum transmitted over the secure communication channel interface.

2. The system of claim 1, wherein establishing the security baseline parameter comprises receiving from the user client device a plurality of authentication factors.

3. The system of claim 1, wherein the computing device is configured to:
identify a corruption datum corresponding to the health record; and
delete the health record as a function of the corruption datum.

4. The system of claim 1, wherein the computing device is configured to delete the health record upon the secure communication channel interface terminating.

5. The system of claim 1, wherein the computing device is configured to receive from the user client device a recorded session datum.

6. The system of claim 1, wherein the computing device is configured to request from the user client device a plurality of authentication factors as a function of a change in the security baseline parameter.

7. The system of claim 1, wherein the computing device is configured to transmit the health record to a health record database.

8. The system of claim 1, wherein the computing device is configured to receive from the user client device a health record validation datum.

9. The system of claim 8, wherein the computing device is configured to receive from the user client device a health record validation datum as a function of user input.

10. The system of claim 1, wherein the computing device is configured to alert a security professional as a function of a change in the security baseline parameter.

11. A method of generating a secure communication channel interface, the method comprising:
using at least a processor of a computing device, transmitting, to a user client device, a configuration packet uniquely identifying the computing device;
using the at least a processor, receiving, from the user client device, an authentication datum;
using the at least a processor, initiating a secure communication channel interface with the user client device as a function of the authentication datum;
using the at least a processor, establishing a security baseline parameter, wherein establishing the security baseline parameter comprises:
identifying a network parameter;
identifying a baseline audiovisual measurement;
identifying a biometric identifier of a user; and
identifying a user environment landmark comprising a physical object;
using the at least a processor, identifying a user health datum as a function of the security baseline parameter;
using the at least a processor, sharing a health record of the user health datum using the secure communication channel interface; and
using the at least a processor, transcribing audio information of the user health datum transmitted over the secure communication channel interface.

12. The method of claim 11, wherein establishing the security baseline parameter comprises receiving from the user client device a plurality of authentication factors.

13. The method of claim 11, wherein the method further comprises:
using the at least a processor, identifying a corruption datum corresponding to the health record; and
using the at least a processor, deleting the health record as a function of the corruption datum.

14. The method of claim 11, wherein the method further comprises, using the at least a processor, deleting the health record upon the secure communication channel interface terminating.

15. The method of claim 11, wherein the method further comprises, using the at least a processor, receiving from the user client device a recorded session datum.

16. The method of claim 11, wherein the method further comprises, using the at least a processor, requesting from the user client device a plurality of authentication factors as a function of a change in the security baseline parameter.

17. The method of claim 11, wherein the method further comprises, using the at least a processor, transmitting the health record to a health record database.

18. The method of claim 11, wherein the method further comprises, using the at least a processor, receiving from the user client device a health record validation datum.

19. The method of claim 18, wherein the user client device a health record validation datum is received as a function of user input.

20. The method of claim 11, wherein the method further comprises, using the at least a processor, alerting a security professional as a function of a change in the security baseline parameter.
